(19) United States
(12) Patent Application Publication
(10) Pub. No.: US 2025/0197666 A1
(43) Pub. Date: Jun. 19, 2025

(54) Battery Cell With Safety Layer

(71) Applicant: DURACELL U.S. OPERATIONS, INC., Wilmington, DE (US)

(72) Inventors: Jonathan Knotts, Nashua, NH (US); Kayla Mooney, Bethel, CT (US); David L. Pappas, Bethel, CT (US)

(21) Appl. No.: 18/542,560

(22) Filed: Dec. 15, 2023

(51) Int. Cl. C09D 139/06; C09D 7/63; H01M 10/48; H01M 50/109; H01M 50/121; H01M 50/124; H01M 50/186

(52) U.S. Cl. CPC C09D 139/06; C09D 7/63; H01M 10/488; H01M 50/109; H01M 50/121; H01M 50/1245; H01M 50/186; H01M 2200/00

(57) ABSTRACT

A battery cell comprising a composite water-responsive safety layer and/or composite water- and pH-responsive safety layer to protect against bodily tissue damage and/or electrolysis, when the battery cell is exposed to aqueous solution or bodily tissue, is provided.

### FIELD OF THE INVENTION

The present disclosure relates to battery cells and, more particularly, to battery cells with a water-responsive safety layer which can be solubilized quickly such that it can advantageously release an aversive agent substantially immediately upon contact with an aqueous solution, for example, when the battery cell is exposed to an aqueous solution or a bodily tissue.

### BACKGROUND

Electrochemical cells, or batteries, are commonly used as electrical energy sources. Small batteries are especially useful in powering consumer products. Small batteries come in a variety of cell types. Common small battery cell types are AAAA, AAA, AA, B, C, D, 9V, CR2, and CR123A. Other types of small batteries known as button cells (also including wider cells sometimes referred to as “coin cells”) are frequently used to power a variety of products including but not limited to watches, cameras, calculators, key-less entry systems for vehicles, laser pointers, glucometers, etc.

FIG. 1 illustrates the construction of a representative prior art button cell 10 comprising a cathode 12 and an anode 16 disposed in a housing comprising a cathode cup 14, corresponding to a positive battery terminal, and an anode lid 18, corresponding to a negative battery terminal, respectively. A separator 20 physically separates and electronically insulates the anode 16 from the cathode 12. An insulating gasket 22 serves to seal the cell to prevent electrolyte loss, to prevent ingress of ambient atmospheric components into the cell, and to electronically insulate the cathode cup 14 from the anode lid 18. Button cells usually have a long service life, for example, typically well over a year in continuous use in a wristwatch. In addition, most button cells have low self-discharge such that they hold their charge for relatively long times when not placed under load.

While button cell batteries are common in many portable consumer electronic devices, the size, shape, and appearance of these batteries, particularly “coin cells”, such as 2016 lithium cells, 2025 lithium cells, and 2032 lithium cells which are characterized by a diameter of 20 mm, can pose swallowing dangers. These dangers can result in bodily harm, especially if the button cell battery is swallowed unbeknownst to others around. And some of these button cell batteries can pose a relatively greater danger than others. For example, coin cell batteries such as 2016 3V lithium cells, 2025 3V lithium cells, and 2032 3V lithium cells, which are based on lithium-manganese dioxide chemistry, are sized such that they can become lodged in a throat, particularly a relatively smaller throat of a toddler, infant, or pet. Because of the electrical charges stored in the batteries and because of the exposed poles, a battery could cause electrolysis of body fluids and/or burning of esophageal and/or other bodily tissue, for example, if swallowed.

It is therefore desirable to provide consumer batteries, in particular, relatively smaller batteries, such as coin cells, that are sized such that they can become lodged in a throat and cause electrolysis of body fluids and/or burning of esophageal/body tissue, for example, if swallowed, with features that discourage swallowing by infants, toddlers, and pets. One innovation to help keep individuals safer involves providing a bitter coating on the coin cell battery (see, for example, “CR2032 Lithium Coin Battery with Bitter Coating,” DURACELL US Operations Inc.). As commercialized, the bitter coating has been deposited as a water-soluble polymeric ring on either the cathode cup or the anode lid and enhances child safety by discouraging swallowing. While these prior solutions providing a bitter coating as a water-soluble polymeric ring on either the cathode cup or the anode lid of a coin cell battery are effective for delivering the aversive agent substantially immediately upon introduction of the battery into an aqueous fluid such as saliva, these prior solutions can cause interference between a device contact and the battery terminal corresponding to the cathode cup or the anode lid, respectively (depending on the location of the bitter coating), thereby impeding current flow and limiting the utility of these solutions. Such interference is even more problematic in devices having cavities designed to accept two or more stacked lithium button cells, particularly coin cells.

### SUMMARY OF THE INVENTION

In one aspect, the disclosure provides a battery comprising a housing, the housing comprising a cathode cup corresponding to a positive battery terminal and an anode lid corresponding to a negative battery terminal; a cathode and an anode disposed within the housing; an insulating gasket disposed between the cathode cup and the anode lid, the insulating gasket sealing the housing and electronically insulating the cathode cup from the anode lid; and a water-responsive safety feature comprising a polymer blend and an aversive agent, the polymer blend comprising a first polyvinylpyrrolidone and a polymer comprising alkyl acrylate monomers, wherein the first polyvinylpyrrolidone has high water solubility.

In another aspect, the disclosure provides a battery comprising a housing, the housing comprising a cathode cup corresponding to a positive battery terminal and an anode lid corresponding to a negative battery terminal; a cathode and an anode disposed within the housing; an insulating gasket disposed between the cathode cup and the anode lid, the insulating gasket sealing the housing and electronically insulating the cathode cup from the anode lid; and a water-responsive safety feature comprising a polymer blend and an aversive agent, the polymer blend comprising a first water-soluble polymer having high water solubility, a hydrolytically stable polymer, and an aversive agent.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 illustrates a conventional prior art button cell; and

FIGS. 2A and 2B illustrate an exemplary battery according to the disclosure, in the form of a coin cell, having a water-responsive safety feature comprising a polymer blend and an aversive agent disposed in the gap between the positive and negative battery terminals.

### DETAILED DESCRIPTION

The present disclosure advantageously provides a battery with a water-responsive safety feature that is sufficiently quickly solubilized such that it can advantageously release an aversive agent substantially immediately upon contact with an aqueous solution, such as saliva, or other fluid, thereby discouraging swallowing by quickly alerting an individual such as an infant, toddler, or pet to the presence of an undesirable object in his/her mouth and promoting expectoration of the battery. Furthermore, the present disclosure provides such a water-responsive safety feature in a specific location of the battery that will advantageously not impede electrical conductivity between any device contact(s) and any battery terminal(s), even when the batteries are button cells arranged in a stacked configuration.

The specific location on the battery cell between the positive and negative terminals presents significant interrelated environmental, mechanical, and electrical stability challenges, however. More specifically, the present disclosure provides a water-responsive safety feature comprising a polymer blend and an aversive agent in a “gap” corresponding to the location between the positive and negative terminals of the battery, e.g., between the cathode cup and the anode lid of a button cell, particularly a coin cell, battery. In other battery forms, such as a cylindrical alkaline battery, the water-responsive safety feature may be disposed in a gap between a positive terminal corresponding to a battery can and a negative terminal corresponding to the battery end cap (for example, with an insulating gasket separating the cover as it is received by the can, in a manner similar to the anode lid being received by the cathode cup in the button cell construction shown in the accompanying FIGS.). The gap between the positive and negative terminals of a battery can be a very reactive space, as it is subject to a battery's cell potential (which can be greater than 3V for a conventional lithium coin cell). As a result, providing the water-responsive safety feature in this location presents significant challenges as the coating must be sufficiently environmentally stable, sufficiently electrically stable, and sufficiently mechanically stable, while also being capable of being sufficiently solubilized to provide release of an aversive agent substantially immediately upon contact with an aqueous solution, such as saliva, or other aqueous fluid as described above. Purposefully positioning the water-responsive safety feature according to the present disclosure in this challenging, reactive space between the positive and negative terminals of the battery, advantageously avoids causing interference between a device contact and the battery terminals. However, because of the high potential, materials placed in this reactive location are highly susceptible to corrosion and even short circuiting of the battery, and these problems are exacerbated by the hygroscopic nature of the involved materials used to provide the water-responsive safety feature, as these are necessarily water-soluble.

In order to address these environmental, electrical, and mechanical challenges, the batteries according to the disclosure advantageously include a water-responsive safety feature comprising a polymer blend and an aversive agent, the polymer blend comprising a first water-soluble polymer having high water solubility (also referred to as a highly water-soluble polymer) and a hydrolytically stable polymer, in the gap between the positive and negative terminals of a battery. For example, to address these environmental, electrical, and mechanical challenges, the batteries according to the disclosure may advantageously include a water-responsive safety feature comprising a polymer blend and an aversive agent, the polymer blend comprising a first polyvinylpyrrolidone and a polymer comprising alkyl acrylate monomers, wherein the first polyvinylpyrrolidone has high water-solubility, in the gap between the positive and negative electrodes. Surprisingly, despite being fabricated from water-soluble materials, the water-responsive safety feature comprising a polymer blend and an aversive agent can demonstrate enhanced resistance to both corrosion and electrical short-circuiting, while maintaining sufficient structural integrity (e.g., adhesion, edge definition, minimal delamination are observed over accelerated aging conditions), and capability to be sufficiently solubilized such that it can advantageously release an aversive agent substantially immediately upon contact with an aqueous solution, such as saliva, or other fluid. Moreover, as described in the Examples, despite being fabricated from water-soluble materials, incorporating the aforementioned water-responsive safety feature as a substantially continuous concentric coating substantially covering the insulating gasket and extending between the terminals also surprisingly increased leakage resistance by significant amounts (relative to cells without the water-responsive safety feature).

As used herein, the term “water-responsive” refers to a safety feature that is capable of being sufficiently solubilized such that it can advantageously release an aversive agent contained therein substantially immediately upon contact with an aqueous solution, such as saliva, or other fluid. In embodiments, the safety feature releases more than about 20 weight % (wt. %), more than about 25 wt. %, and/or more than about 30 wt. %, of the aversive agent contained therein over a period of 5 seconds when immersed in an aqueous solution.

As used herein, “high water-solubility” refers to the solubility of a given polymer, material, or other substance in water, at about 20° C., of greater than about 100 g/L, for example, greater than about 250 g/L, greater than about 500 g/L and/or greater than about 1000 g/L. Generally, water-solubility can be determined by measuring 100 ml of water accurately, adding small amounts of the material until saturation (i.e., no more can dissolve), filtering the mixture to remove any undissolved solid, and evaporating the water to determine the weight of the dissolved solute and thus the solubility of the given material in 100 mL. Water solubility values for polymers can sometimes be found in the literature, but may also be determined herein using the “flask method” or the “column elution method”. As described in Organisation for Economic Cooperation and Development (OECD), “Test No. 105: Water solubility,” OECD Guideline for the Testing of Chemicals, adopted Jul. 27, 1995 (7 pp.), which is hereby incorporated herein by reference, the column elution is used for substances with low solubilities (solubility less than 10 mg/L) and the flask method is used for substances with higher solubilities (solubility greater than 10 mg/L).

In brief, water solubility can be determined in water at a relevant temperature. In the flask method, the test substance is first pulverized by grinding and weighed into a vessel, such that approximately 5× the quantity determined by a preliminary test is weighed into a vessel and then the indicated amount of water is added to the vessel (e.g., 1L). When saturation is achieved, the mixture is cooled to the test temperature and stirring is performed until equilibrium is reached. The mass concentration of the test substance dissolved in the aqueous solution (it must not contain undissolved particles) can be determined analytically by any useful methodology (e.g., gas or liquid chromatography, titration, photometry, and/or voltammetry). Gas chromatography is preferred. In the column elution method, a microcolumn including an excess of the test substance with an inert carrier (e.g., beads, silica, sand, etc.), is eluted with water and the mass concentration of the substance in the eluate is determined when the concentration of the eluate is constant. This method is based on the elution of the test substance with water at constant temperature from a column charged with the substance which is finely distributed on an inert support material. The flow rate of the water should be adjusted so that a saturated solution leaves the column. Saturation is achieved when, in consecutive fractions of the eluate at different flow rates, the mass concentration-determined by a suitable method—is constant. This is shown by a plateau when the concentration is plotted against time or eluted volume. As noted above, the mass concentration of the test substance dissolved in the aqueous solution can be determined analytically by any useful methodology (e.g., gas or liquid chromatography, titration, photometry, and/or voltammetry). Gas chromatography is preferred.

The first water-soluble polymer having high water solubility effectively serves as a primary delivery vehicle for the aversive agent contained within the water-responsive safety feature. Generally, the highly water-soluble polymer is chosen from one or more in the group of polyethylene glycols, polyacrylic acids, polyamides, polyvinyl alcohols, polyvinyl pyrrolidones, hydroxylpropylmethyl celluloses, hydroxypropylcelluloses, and copolymers including monomeric units of one or more of the foregoing polymers. More typically, the highly water-soluble polymer comprises a polyvinylpyrrolidone polymer. Thus, a (first) polyvinylpyrrolidone polymer may be provided as the highly water-soluble polymer in the blend of polymers.

The degree of polymerization for a highly water-soluble polymer has been found to be an important characteristic with respect to achieving substantially immediate dissolution thereof when contacted with an aqueous solution such as saliva or stomach fluids. Highly water-soluble polymers with a degree of polymerization between about 60 and about 100, for example, between about 70 and about 90, demonstrate excellent solubility substantially immediately when contacted with saliva, stomach fluids, or other aqueous fluids, and thereby can help facilitate substantially immediate release and delivery of the aversive agent, for example, to an individual's mouth.

The highly water-soluble polymer typically has a number average molecular weight between about 500 and about 65,000, for example, between about 1000 and about 60,000, between about 1500 and about 55,000, between about 2000 and about 50,000, between about 2500 and about 45,000, between about 3000 and about 40,000, between about 4000 and about 35,000, between about 5000 and about 30,000, and/or between about 5500 and about 15,000, for example, about 9000 grams/mol. Generally, herein, molecular weight refers to number average molecular weight determined by gel permeation/size exclusion chromatography with light scattering (LS) detector. As mentioned above, a (first) polyvinylpyrrolidone polymer may be provided as the highly water-soluble polymer in the blend of polymers. Thus, the first polyvinylpyrrolidone may have a number average molecular weight between about 500 and about 65,000, for example, between about 1000 and about 60,000, between about 1500 and about 55,000, between about 2000 and about 50,000, between about 2500 and about 45,000, between about 3000 and about 40,000, between about 4000 and about 35,000, between about 5000 and about 30,000, and/or between about 5500 and about 15,000, for example, about 9000 grams/mol. Providing a highly water-soluble polymer with a molecular weight in the foregoing ranges is important for achieving sufficient solubilization of the water-responsive safety feature to provide release of the aversive agent substantially immediately upon contact with an aqueous solution. Suitable highly water-soluble polymers include polyvinylpyrrolidone polymers sold under the LUVITEC® tradename such as LUVITEC® K 17 and LUVITEC® K30 (BASF), polyvinylpyrrolidone polymers sold under the SOKALAN® tradename, specifically SOKALAN® K 17 P and SOKALAN® K 30 P (BASF), as well as those sold under the PLASDONE™ tradename such as PLASDONE™ K-12 povidone, PLASDONE™ K-17 povidone and PLASDONE™ K-25 povidone (Ashland Inc.). Of course, other highly water-soluble polymers including other polyvinylpyrrolidone polymers may also be used.

Including too much of the highly water-soluble polymer can result in the water-responsive safety feature being too (mechanically) fragile. In addition, including too much of the highly water-soluble polymer can result in the water-responsive safety feature being too hygroscopic, which can be particularly problematic in terms of maintaining sufficient electrical stability and mechanical stability, with the water-responsive safety feature being too frangible and even potentially corroding and/or causing the battery to short. On the other hand, including too little of the highly water-soluble polymer can cause the water-responsive safety feature to become incapable of delivering the aversive agent substantially immediately upon contact with an aqueous solution, such as saliva, or other fluid. Thus, the amount of the highly water-soluble polymer is important for providing the desired environmental stability, electrical stability, and mechanical stability to the water-responsive safety feature. Generally, in order to provide the desirable stability, the water-responsive safety feature comprises the highly water-soluble polymer in an amount of at least about 1 weight % (wt. %), at least about 5 wt. %, at least about 7.5 wt. %, and/or at least about 10 wt. %, for example, between about 5 wt. % and about 25 wt. %, between about 5 wt. % and about 20 wt. %, or between about 7.5 wt. % and about 15 wt. %, based on total solids (may also be described as the dry weight of the water-responsive safety feature).

A “hydrolytically stable polymer” as used herein generally refers to a polymer that resistant to hydrolysis, such that the hydrolytically stable polymer cannot be depolymerized, softened, or otherwise degraded by presence of and/or reaction with water. The hydrolytically stable polymer is generally included to provide desirable mechanical properties to the water-responsive safety feature. Hydrolytic stability of polymers may also be tested using IPC-TM-650 Method 2.6.11 as specified in IPC-SM-817 Section 4.5.15. Test specimens can be prepared by stenciling polymer layers 0.25±0.05-mm thick. The specimens should be free of air bubbles or voids when examined under backlighting. Test samples can then be exposed to 94±4% RH and 97±2° C. for 28 days and examined visually for evidence of reversion indicated by softening, chalking, blistering, cracking, tackiness, loss of adhesion, or liquefication.

Generally, the hydrolytically stable polymer is chosen from one or more in the group of acrylics, epoxies, acrylates, and urethanes. More typically, the hydrolytically stable polymer is a polymer (or copolymer) comprising one or more alkyl acrylate monomers. Thus, a polymer comprising alkyl acrylate monomers may be provided as the hydrolytically stable polymer in the blend of polymers. The polymer comprising alkyl acrylate monomers may be chosen from one or more in the group of a polymer comprising methyl methacrylate monomers, a polymer comprising ethyl methacrylate monomers, a polymer comprising propyl methacrylate monomers, and a polymer comprising butyl methacrylate monomers. The polymer comprising alkyl acrylate monomers may be chosen from one or more in the group of a copolymer comprising methyl methacrylate and ethyl methacrylate monomers, a copolymer comprising methyl methacrylate and propyl methacrylate monomers, a copolymer comprising methyl methacrylate and butyl methacrylate monomers, a copolymer comprising ethyl methacrylate and propyl methacrylate monomers, a copolymer comprising ethyl methacrylate and butyl methacrylate monomers, and a copolymer comprising propyl methacrylate and butyl methacrylate monomers. Any of the foregoing polymers and copolymers comprising one or more alkyl acrylate monomers may further comprise methacrylic acid monomers. In one embodiment, the polymer comprising alkyl acrylate monomers is a poly(methyl methacrylate/ethyl acrylate/methacrylic acid).

The hydrolytically stable polymer typically has a number average molecular weight between about 10,000 and about 120,000, for example, between about 15,000 and about 110,000, between about 20,000 and about 100,000, between about 25,000 and about 90,000, and/or between about 40,000 and about 80,000, for example, about 60,000 grams/mol. Thus, the polymer (or copolymer) comprising alkyl acrylate monomers may have a number average molecular weight between about 10,000 and about 120,000, for example, between about 15,000 and about 110,000, between about 20,000 and about 100,000, between about 25,000 and about 90,000, and/or between about 40,000 and about 80,000, for example, about 60,000 grams/mol. Suitable hydrolytically stable polymers include but are not limited to alkyl acrylate polymers sold under the ELVACITE® tradename such as ELVACITE® 4072, ELVACITE® 2927, and ELVACITE® 2669 (Mitsubishi Chemical America Inc.). Of course, other alkyl acrylate polymers may also be used. For example, alkyl acrylate polymers sold under the DORESCO® (The Lubrizol Corporation) and PARALOID™ (The Dow Chemical Company) may also be used.

Including too much of the hydrolytically stable polymer can result in the aversive agent becoming encapsulated by the hydrolytically stable polymer within the water-responsive safety feature and thus essentially inaccessible for delivery when the water-responsive safety feature is contacted with an aqueous solution in the form of saliva, stomach fluids, or other fluid. On the other hand, including too little of the hydrolytically stable polymer can result in the water-responsive safety feature being easily fractured and/or inadvertently removed during transport or storage, as well as increased hygroscopicity of the water-responsive safety feature. Thus, the amount of the hydrolytically stable polymer is important for providing the desired environmental stability, electrical stability, and mechanical stability to the water-responsive safety feature. Generally, to demonstrate the desired environmental stability, electrical stability, and mechanical stability, the water-responsive safety feature comprises the hydrolytically stable polymer in an amount of at least 1 weight % (wt. %), in an amount of at least 5 wt. %, or in an amount of at least 10 wt. %, for example, between about 5 wt. % and about 35 wt. %, or between about 10 wt. % and about 30 wt. %, for example, about 22 wt. %, based on total solids.

In addition to the foregoing highly water-soluble polymer and hydrolytically stable polymers, the blend of polymers of the water-responsive safety feature may further comprise a second water-soluble polymer, typically a (second) polyvinylpyrrolidone, in order to provide the water-responsive safety feature with desired mechanical properties, while facilitating release and delivery of the aversive agent substantially immediately upon contact with an aqueous solution, such as saliva, or other fluid. The second water-soluble polymer generally has a lower water-solubility than the highly water-soluble polymer or first polyvinylpyrrolidone included in the blend of polymers.

Additionally, the second water-soluble polymer or second polyvinylpyrrolidone generally has a higher molecular weight relative to the highly water-soluble polymer or first polyvinylpyrrolidone included in the blend of polymers. For example, the second polyvinylpyrrolidone typically has a number average molecular weight between about 200,000 and about 2,000,000, for example, between about 400,000 and about 1,900,000, between about 600,000 and about 1,800,000, between about 800,000 and about 1,700,000, and/or between about 1,000,000 and 1,600,000, for example, about 1,400,000 grams/mol. Thus, the second water-soluble polymer may have a number average molecular weight at least about 50-fold higher, at least about 75-fold, at least about 100-fold higher, and/or at least about 125-fold higher relative to the number average molecular weight first water-soluble polymer. Thus, the second water-soluble polymer typically has a solubility in water that is significantly less, for example, at least 10%, at least 20%, and/or at least 50% less than the solubility in water of the first water-soluble polymer. Suitable second water-soluble polymer include polyvinylpyrrolidone polymers sold under the LUVITEC® tradename such as LUVITEC® K 82, LUVITEC® K 85, and LUVITEC® K 90 (BASF), polyvinylpyrrolidone polymers sold under the SOKALAN® tradename, specifically SOKALAN® K 90 P, as well as those sold under the PLASDONE™ tradename such as PLASDONE™ K-90 povidone (Ashland Inc.). Of course, other water-soluble polymers including other polyvinylpyrrolidone polymers may also be used.

In order to provide sufficient mechanical stability, while facilitating delivery of the aversive agent, the water-responsive safety feature comprises the second polyvinylpyrrolidone in an amount of at least about 10 weight % (wt. %), at least about 25 wt. %, at least about 35 wt. %, and/or at least about 40 wt. %, for example, between about 5 wt. % and about 65 wt. %, or between about 30 wt. % and about 60 wt. %, for example, about 50 wt. %, based on total solids.

For example, cells having water-responsive safety features as described herein preferably can be stored for at least 10 days, at least 30 days, at least 60 days, at least 84 days in environments having relative humidity values of up to 90% (at temperatures between about 20° C. and about 50° C., for example, at about 30° C., or at about 40° C.), without affecting battery cell performance. Additionally, cells having water-responsive safety features as described herein preferably can be stored for at least 60 days, at least 90 days, and/or at least 1200 days in environments having relative humidity values of up to 65% (at temperatures between about 20° C. and about 50° C., for example, at about 30° C., or at about 40° C.), without affecting battery cell performance.

As described throughout, the water-responsive safety feature comprises an aversive agent. The water-responsive safety layer may comprise an aversive agent chosen from one or more aversive agents in the group of denatonium benzoate, ammonium benzoate, denatonium saccharide, denatonium chloride, sucrose octaacetate, 2,3-dimethoxystrychnine, quassinoids, flavonoids, quercetin, absinthe, resinferatoxin, capsaicin, nonivamide, piperine, and allyl isothiocyanate. Generally, the aversive agent comprises a bitterant, typically, denatonium benzoate. The water-responsive safety feature typically comprises greater than about 1 wt. %, greater than about 3 wt. %, greater than about 5 wt. %, for example, from about 1 wt. % to about 10 wt. %, or from about 3 wt. % to about 7.50 wt. %, for example, about 6.50 wt. %, of the aversive agent, typically, denatonium benzoate, based on total solids.

Additionally, the water-responsive safety feature may include a colorant (e.g., a dye, a pigment, a polymeric dye, or a combination thereof). A colorant may be included in the water-safety responsive feature and be capable of being delivered therefrom during dissolution and thus elution of the more water-soluble polymeric vehicle(s) (and any aversive agent (also) dispersed therein) from the bulk of the water-responsive safety feature. Thus, the colorant may facilitate detection that a battery has been swallowed, by promoting expectoration of a colored fluid (or “spit-up”) from the mouth of an individual that signals accidental swallowing to another, thereby advantageously allowing an adult or caregiver to more rapidly identify the child's potential ingestion of the battery. Generally, the colorant should be present in the water-responsive safety feature in an amount sufficient to bring about a visible color change in an aqueous fluid substantially immediately upon contact. For example, the colorant may be included from about 0.1 wt. % to about 5 wt. %, from about 0.1 wt. % to about 2.0 wt. %, for example, about 0.70 wt. %, of the colorant, typically, a dye, based on total solids.

The battery surfaces may be activated by any suitable surface activation technique, for example, plasma treatments including but not limited to argon or corona treatments, UV/ozone treatments, flame treatments, chemical treatments including but not limited to acid treatments, base treatments, and the like. Such treatment prior to deposition may increase adhesion of the water-responsive safety feature to the battery surfaces. Adhesion promoters, especially silane adhesions promoters can enhance adhesion of the water-responsive safety feature to the battery surfaces, especially after the surfaces have been activated using a UV/ozone treatment. Representative adhesion promoters include but are not limited to Di-Alkoxy Silanes such as Diethoxydimethylsilane; Diethoxy(methyl) vinylsilane; 1,3-Diethoxy-1,1,3,3-tetramethyldisiloxane; Dimethoxydimethylsilane; Dimethoxydimethylsilane; Dimethoxymethylvinylsilane; and Methyldiethoxysilane; Mono-Alkoxy Silanes such as Ethoxytrimethylsilane and Methoxytrimethylsilane; Tri-Alkoxy Silanes such as 3-Aminopropyl)triethoxysilane (“APTES”); (Chloromethyl)triethoxysilane; Triethoxy (ethyl) silane; Triethoxymethylsilane; Triethoxymethylsilane; Triethoxyvinylsilane; Trimethoxymethylsilane; Trimethoxymethylsilane; Vinyltrimethoxysilane; and Vinyltrimethoxysilane; Trihalosilanes such as tert-Butyltrichlorosilane; Di-n-octyldichlorosilane; Hexachlorodisilane; Methyltrichlorosilane; Methyltrichlorosilane; Trichloro(dichloromethyl)silane; Trichlorovinylsilane; Bis-Silanes such as 1,2-Bis(triethoxysilyl)ethane; 1,2-Bis(trimethoxysilyl)ethane; 1,2-Bis(trichlorosilyl)ethane; and Bis(trichlorosilyl)methane; and combinations thereof.

The water-responsive safety feature may further comprise an additive such as a rheology modifier or a porogen. The rheology modifier may be used to maintain the rheology of a liquid form of the water-responsive safety feature during preparation, deposition, and/or drying to mitigate quick settling thereof. Exemplary stabilizers include dispersants such as polyurethane- and polyacrylic-based dispersants available under the EKFAR PU and EKFAR PA trade names, respectively (BASF Corporation), fumed metal oxide rheology additives including but not limited to those fumed silica and fumed alumina rheology additives available under the AEROSIL® (Evonik) and CAB-O-SIL® trade names (Cabot Corporation), and polysaccharides such as xanthan gum (VANZAN® NF-F, Vanderbilt Minerals, LLC). The porogen may be used to facilitate wetting and promote adhesion. Exemplary porogens include but are not limited to polyethylene glycol, sodium chloride, and sodium hydrogen carbonate. When an additive is included, the water-responsive safety feature typically comprises from about 1 wt. % to about 10 wt. %, or from about 2 wt. % to about 7.50 wt. %, for example, about 5.50 wt. %, of the additive based on total solids.

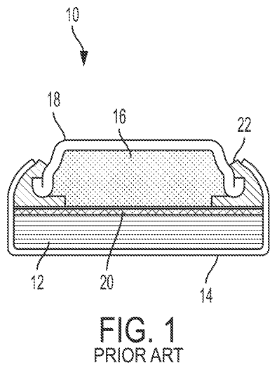

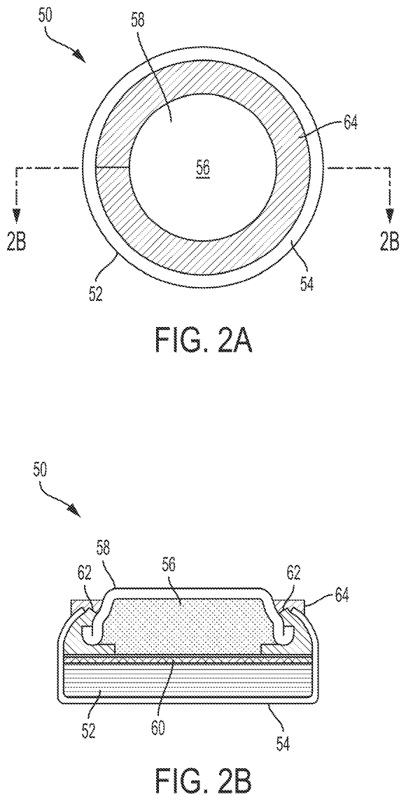

As is well-known, and consistent with the battery 10 shown in FIG. 1, FIGS. 2A and 2B illustrate a battery 50, which may be any type of primary or secondary battery and which is a button cell type battery in the illustrated example. The battery 50 includes a battery housing surrounding the battery, the housing comprising a cathode cup 54 and an anode lid 58, the cathode cup 54 and the anode lid 58 enclosing a cathode 52 and an anode 56 within the housing, the cathode 52 and the anode 56 being separated electronically by a separator 60 within the cell 50. Each of the cathode cup 54 and the anode lid 58 forms a different pole of the battery 50, with the cathode cup 54 corresponding to a positive battery terminal and the anode lid 18 corresponding to a negative battery terminal, respectively. While the cathode cup 54 is shown in the illustrated embodiment of FIGS. 2A and 2B as receiving the anode lid 58 there within, an alternative configuration in which the anode lid 58 receives the cathode cup 54 may be used.

As illustrated in FIG. 2B, the cathode cup 54 and the anode lid 58 are spaced apart by a separator 60 extending across the lateral extent of the cathode 52, e.g., substantially across a diameter of the battery 50, thereby electronically insulating the cathode 52 from the anode 56, while being ionically conductive as is well understood. An insulating gasket 62 typically extends into the cathode cup 54 to provide an insulating material substantially surrounding the anode lid 58, thereby electronically isolating the cathode cup 54 from the anode lid 58, i.e., electronically isolating the positive terminal from the negative terminal, with the insulating gasket also sealing the battery 50 to prevent electrolyte loss. Thus, the insulating gasket 62 seals the housing and electronically insulates the battery terminals from one another.

As best illustrated in FIG. 2B, the battery 50 further includes a water-responsive safety feature 64 generally provided over and as illustrated also in direct contact with the insulating gasket 62. The water-responsive safety feature 64 is comprised of a polymer blend including an aversive agent dispersed therein. In the illustrated embodiment, the composite water-responsive safety feature 64 contacts a portion of the cathode cup 54 and a portion of the anode lid 58, and extends there between, such that the water-responsive safety feature provides a substantially continuous coating over (and as illustrated in direct contact with) the insulating gasket 62 from the cathode cup 54 to the anode lid 58. Thus, the water-responsive safety feature 64 is typically provided as a coating, specifically, a coating comprising a combination of polymers that in concert are capable of delivering the aversive agent substantially immediately upon exposure to an aqueous fluid such as saliva, stomach fluids, or other aqueous fluid, while maintaining each of (i) sufficient mechanical integrity to remain in place over storage and transport (for example, as demonstrated by adhesion and maintenance of discrete structure), (ii) sufficient electrical stability to resist corrosion and shorting (for example, as demonstrated by low degrees of opacification of the water-responsive safety feature and electrical shorting of cells), and (iii) sufficient environmental stability to avoid significant water adsorption during storage and transport, especially when exposed to high humidity (for example, as demonstrated by significant weight increase after accelerated aging testing), as water-adsorption can promote degradation of both mechanical stability and electrical stability. Thus, the water-safety feature 64 must be capable of being solubilized without being too hygroscopic, too conductive, or too fragile.

When the water-safety feature is too hygroscopic, the adsorbed water can facilitate migration of any electronically or ionically conductive material contained therein (or introduced adjacent thereto, for example, because of cell leakage) and thereby increase corrosion and/or shorting of the cells. Thus, in one refinement, the water-safety feature composition is substantially free of electronically or ionically conductive material including but not limited to metal salts, acids, metals, and carbons. For example, as used herein, “substantially free of electronically or ionically conductive material”, means that the compositions used to provide water-safety feature according to the disclosure contain insignificant amounts of electronically or ionically conductive material(s) (referring to % mass of solids). For example, the compositions used to provide water-safety feature according to the disclosure may contain less than 2.0 wt. %, less than 1.0 wt. %, less than 0.5 wt. %, of electronically or ionically conductive material(s) based on total solids.

Electrochemical cells, or batteries, used in accordance with the present disclosure may be primary or secondary. Primary batteries are meant to be discharged, e.g., to exhaustion, only once and then discarded. Primary batteries are described, for example, in David Linden, Handbook of Batteries (McGraw-Hill, 4^{th} ed. 2011). Secondary batteries are intended to be recharged. Secondary batteries may be discharged and then recharged many times, e.g., more than fifty times, more than a hundred times, or more than a thousand times. Secondary batteries are described, e.g., in David Linden, Handbook of Batteries (McGraw-Hill, 4^{th} ed. 2011). Batteries may contain aqueous or non-aqueous electrolytes. Accordingly, batteries according to the disclosure may include various electrochemical couples and electrolyte combinations. While batteries incorporating a composite water-responsive safety feature are exemplified and described herein using a button cell, more specifically a coin cell, generally, any battery type including but not limited to common consumer batteries such as AAAA, AAA, AA, B, C, D, 9V, CR2, CR123A, ⅓N, button cells, and coin cells, such as 2016 lithium cells, 2025 lithium cells, and 2032 lithium cells, may be modified to include a water-responsive safety feature disposed between the positive and negative terminals as described herein.

Advantageously, application of a water-responsive safety feature as disclosed herein does not affect battery cell performance; thus, for example, the battery has substantially the same voltage and capacity before and after the composite water-responsive safety feature is provided in the gap between the positive and negative terminals of the battery.

In a representative example, the water-responsive safety feature 64 is formed by combining a blend of polymers comprising a first water-soluble polymer having high water solubility and a hydrolytically stable polymer in an aqueous solution comprising a diacetone alcohol, with an aversive agent and optionally a colorant such as a dye, in water in a vessel on a hot plate held at about 50° C. to about 60° C. and then depositing the composition on or about at least a portion of the insulating gasket 62, preferably using a direct-write dispenser. By covering at least a portion of the insulating gasket 62 with the composition comprising the blend of polymers and an aversive agent, when an individual swallows the battery cell 50, so as to expose the battery cell 50 to an aqueous solution in the form of saliva, stomach fluids, or other fluid, at least one polymer in the blend of polymers of the water-responsive safety feature is substantially immediately solubilized, thereby releasing and delivering the aversive agent, for example, to an individual's mouth, preferably without the water-responsive safety feature itself substantially dissolving or becoming dislodged in whole or in part from the battery. The water-safety feature components are typically described herein by % mass of solids (nominally, weight percent, or wt. %). Thus, any solvents (including water) that are used to solubilize the components during deposition/casting and evaporate are excluded for this purpose. While the composite water-responsive layer is shown as contacting both a portion of the anode lid 58 and a portion of the cathode cup 54, contact with the battery poles is not necessary.

Throughout this specification, plural instances may implement components or structures described as a single instance. Structures and functionality presented as separate components in example configurations may be implemented as a combined structure or component. Similarly, structures and functionality presented as a single feature may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, an element A or B is satisfied by any one of the following: A is present and B is not present, A is not present and B is present, and both A and B are present.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

The following examples further illustrate the advantages of battery cells including a water-responsive safety feature as disclosed herein.

### Example 1

In this example, the performance of a water-responsive safety feature comprising a polymer blend and an aversive agent according to the disclosure was compared with the comparative prior art formulation utilized in the CR2032 Lithium Coin Battery with Bitter Coating (DURACELL US Operations Inc.), with each of these formulations was provided in the “gap” corresponding to the location between the positive and negative terminals of the battery, e.g., between the cathode cup and the anode lid of a coin cell battery.

The comparative, prior art formulation was not stable when disposed between the positive and negative terminals of a coin cell, and induced corrosion and/or shorting when exposed to the elevated temperatures and humidity in accelerated aging and safety/abuse testing.

The water-responsive feature according to the instant disclosure was prepared from the composition shown in Table I, below:

| Component | Raw Material | Weight % |
|---|---|---|
| LUVITEC ® K 17 | Polyvinylpyrrolidone | 0.93 |
| LUVITEC ® K90 | Polyvinylpyrrolidone | 3.74 |
| E133 - FD&C Blue #1 | Triarylmethane Dye | 1.50 |
| BITREX ® (Anhydrous) | Denatonium Benzoate | 0.45 |
| VANZAN ® NF-F | Xanthan Gum | 0.38 |
| ELVACITE ® 2669 | Methyl Methacrylate Copolymer | 1.56 |
| Diacetone Alcohol (DAA) | Organic Solvent | 72.68 |
| Water | Aqueous Solvent | 18.76 |

The formulation in Table 1 was prepared on a hot plate, where a water bath was maintained at 50-60° C. A mixing vessel was placed into this bath, and a mixing blade was mounted 1 inch from the bottom. To this vessel, diacetone alcohol solvent (DAA) and the methyl methacrylate copolymer (ELVACITE® 2669) were added. Mixing and heating continued until the solution was clear and colorless, up to 2 hours. The next steps were the gradual addition of more solvent and the two PVP resins (LUVITEC® K 17 and LUVITEC® K 30). Mixing speed was increased and heating continued until all polymers were dissolved and solution was clear and colorless (up to 4 hours). Water and xanthan gum were then slowly added, followed by denatonium benzoate. Heated mixing continued until the solution was clear, colorless, and free of clumps. Finally, the blue dye was added. The mixing speed was increased and the solution was heated for an additional 2 hours. The mixture was removed from heat and allowed to cool before transferring to HDPE bottles. The formulation was deposited using a direct-write n in the gap corresponding to the location between the positive and negative terminals of the coin cells. No corrosion, shorting, or leakage was detected after the cells were exposed to the elevated temperatures and humidity in accelerated aging and safety/abuse testing.

Furthermore, analytical testing determined that a significant portion, namely, 45 wt. %-59 wt. %, of the denatonium benzoate was delivered substantially immediately within five seconds from a film manufactured from the foregoing formulation when immersed in Ringer's solution and/or an aqueous solution comprising 60 wt. % methanol. The combination of polymers in the foregoing formulation therefore advantageously provides excellent delivery of the aversive agent, while enhancing resistance to corrosion, shorting, and leakage.

### Example 2

In this example, the performance of a water-responsive safety feature comprising a polymer blend and an aversive agent disposed in the “gap” corresponding to the location between the positive and negative terminals of the battery, e.g., between the cathode cup and the anode lid of a coin cell battery, was compared with a comparative “bare” coin cell without any water-responsive safety feature.

The cells were subjected to a Temperature Humidity Test (THT), during which both the batteries according to the disclosure and the bare batteries were subjected to a relatively constant temperature of 40° C. and relative humidity of 90%. Leakage is typically confirmed by visual inspection. In this respect, the appearance of white and/or green crystals on or around the insulating gasket separating the positive and negative terminals corroborates leakage. Whereas 30% of the bare cells showed evidence of leakage, the cells including a water-responsive safety feature surprisingly and unexpectedly did not exhibit any signs consistent with leakage. This result is particularly surprising given that the water-responsive safety feature is produced using water-soluble materials.

In addition, the adhesion of the water-responsive safety feature to the cells was tested according to ASTM D3359. Specifically, an X-cut is made in the water-responsive safety feature to the substrate to which it is adhered (e.g., the insulating gasket), pressure-sensitive tape is applied over the cut and then removed, and adhesion is assessed qualitatively on the 0 to 5 scale, with the score of 0 corresponding to removal of 100% of the film, the score of 1 corresponding to removal of most of the area under the tape, the score of 2 corresponding to removal of up to 30% of the water-responsive safety feature (or “ring” as applied), the score of 3 corresponding to removal of up to 10% of the water-responsive safety feature (or “ring” as applied), the score of 4 corresponding to trace removal, and the score of 5 corresponding to no peeling or removal.

1. A battery comprising:
a housing comprising a cathode cup corresponding to a positive battery terminal and an anode lid corresponding to a negative battery terminal;
a cathode and an anode disposed within the housing;
an insulating gasket disposed between the cathode cup and the anode lid, the insulating gasket sealing the housing and electronically insulating the cathode cup from the anode lid; and
a water-responsive safety feature comprising a polymer blend and an aversive agent, the polymer blend comprising a first polyvinylpyrrolidone and a polymer comprising alkyl acrylate monomers, wherein the first polyvinylpyrrolidone has high water solubility.

2. The battery of claim 1, wherein the polymer comprising alkyl acrylate monomers is chosen from one or more in the group of a polymer comprising methyl methacrylate monomers, a polymer comprising ethyl methacrylate monomers, a polymer comprising propyl methacrylate monomers, and a polymer comprising butyl methacrylate monomers.

3. The battery of claim 1, wherein the polymer comprising alkyl acrylate monomers is chosen from one or more in the group of a copolymer comprising methyl methacrylate and ethyl methacrylate monomers, a copolymer comprising methyl methacrylate and propyl methacrylate monomers, a copolymer comprising methyl methacrylate and butyl methacrylate monomers, a copolymer comprising ethyl methacrylate and propyl methacrylate monomers, a copolymer comprising ethyl methacrylate and butyl methacrylate monomers, and a copolymer comprising propyl methacrylate and butyl methacrylate monomers.

4. The battery of claim 1, wherein the polymer comprising alkyl acrylate monomers further comprises methacrylic acid monomers.

5. The battery of claim 1, wherein the polymer comprising alkyl acrylate monomers has a number average molecular weight between about 10,000 and about 120,000 grams/mol.

6. The battery of claim 1, wherein the first polyvinylpyrrolidone has a number average molecular weight between about 500 and about 65,000 grams/mol.

7. The battery of claim 1, further comprising a second polyvinylpyrrolidone, wherein the second polyvinylpyrrolidone has a solubility in water that is less than a solubility in water of the first polyvinylpyrrolidone.

8. The battery of claim 7, where the second polyvinylpyrrolidone has a molecular weight between about 200,000 and about 2,000,000 grams/mol.

9. The battery of claim 1, wherein the aversive agent comprises a bitterant.

10. The battery of claim 9, wherein the aversive agent comprises ammonium benzoate, denatonium benzoate, denatonium saccharide, denatonium chloride, sucrose octaacetate, 2,3-dimethoxystrychnine, quassinoids, flavonoids, quercetin, absinthe, resinferatoxin, capsaicin, nonivamide, piperine, allyl isothiocyanate, or a combination of the foregoing.

11. The battery of claim 1, wherein the first polyvinylpyrrolidone is present in an amount of at least about 1 weight % (wt. %), based on total solids.

12. The battery of claim 1, wherein the polymer comprising alkyl acrylate monomers is present in an amount of at least 1 weight % (wt. %), based on total solids.

13. The battery of claim 1, wherein the second polyvinylpyrrolidone is present in an amount of at least about 10 weight % (wt. %), based on total solids.

14. The battery of claim 1, wherein the water-responsive safety feature further comprises a colorant.

15. The battery of claim 1, wherein the battery is selected from a AAAA battery, a AAA battery, a AA battery, a B battery, a C battery, a D battery, a 9V battery, a CR2 battery, a CR123A battery, a ⅓N battery, a button cell, and a coin cell.

16. A battery comprising:
a housing comprising a cathode cup corresponding to a positive battery terminal and an anode lid corresponding to a negative battery terminal;
a cathode and an anode disposed within the housing;
an insulating gasket disposed between the cathode cup and the anode lid, the insulating gasket sealing the housing and electronically insulating the cathode cup from the anode lid; and
a water-responsive safety feature comprising a polymer blend and an aversive agent, the polymer blend comprising a first water-soluble polymer having high water solubility, a hydrolytically stable polymer, and an aversive agent.

17. The battery of claim 16, wherein the water-soluble polymer has a degree of polymerization between about 60 and about 100.

18. The battery of claim 16, wherein the highly water-soluble polymer is chosen from one or more in the group of polyethylene glycols, polyacrylic acids, polyamides, polyvinyl alcohols, polyvinyl pyrrolidones, hydroxylpropylmethyl celluloses, hydroxypropylcelluloses, and copolymers including monomeric units of one or more of the foregoing polymers.

19. The battery of claim 16, wherein the hydrolytically stable polymer is chosen from one or more in the group of acrylics, epoxies, acrylates, and urethanes.

20. The battery of claim 16, wherein the polymer blend further comprises a second water-soluble polymer, the second water-soluble polymer having a number average molecular weight at least about 50-fold higher, at least about 75-fold, at least about 100-fold higher, and/or at least about 125-fold higher relative to the number average molecular weight first water-soluble polymer.
